(19) United States
(12) Patent Application Publication
(10) Pub. No.: US 2007/0168765 A1
(43) Pub. Date: Jul. 19, 2007

(54) METHOD FOR DETECTING AND TRANSMITTING ERROR MESSAGES

(76) Inventors: Yi-Hung Shen, Taipei City (TW); Bo-Cheng Hsu, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,795

(22) Filed: Feb. 22, 2006

(30) Foreign Application Priority Data
Nov. 16, 2005 (TW) 94140225

(51) Int. Cl. G06F 11/00

(52) U.S. Cl. 714/57

(57) ABSTRACT

A method for detecting and transmitting the error messages is provided. The method is suitable for outputting an error message from a local module to a remote module. The method comprises the following steps. First, a controller inside the local module performs an error test procedure and obtains a test result. Next, the controller transmits the test result to an application software in the local module. Finally, the application software transmits the test result to the remote module via a transmission interface.

### CROSS-REFERENCE TO RELATED APPLICATION

This application claims the priority benefit of Taiwan application serial no. 94140225, filed on Nov. 16, 2006. All disclosure of the Taiwan application is incorporated herein by reference.

### BACKGROUND OF THE INVENTION

1. Field of the Invention

The present invention relates to a method for detecting and transmitting the error messages, and more particularly to a method for detecting and transmitting the error messages by using a software module.

2. Description of Related Art

During the circuit board design or fabrication phase, an external trace is welded on the chip or a fixture is used to test and determine whether for any error in the data transmission or whether the chip operates normally.

FIG. 1 is a schematic diagram showing a module for detecting and transmitting the error messages using a fixture. The module comprises a local module 110 and a remote module 130. The local module 110 is connected to the remote module 130 via a fixture 180. The local module 110 comprises an embedded controller 150, a BIOS (Basic Input Output System) 170 and an input device 140.

The embedded controller 150 receives an instruction from the input device 140, for example an instruction to activate the embedded controller 150 to transmit the data or an instruction to be transmitted to other component via embedded controller 150. After the instruction is received and executed by the embedded controller 150, an instruction is sent to the BIOS 170 to trigger the BIOS 170 to transmit the data requested by the instruction to the embedded controller 150, wherein the data, for example, comprises the procedure and results of the error test performed by the BIOS 170. Finally, the embedded controller 150 transmits the data to the fixture 180 and then displayed on the remote module 130.

However, some fixtures are very expensive, and the fabrication process of the fixture is quite complicated, thus it is common limited fixtures are used and shared by multiple engineers, and the fixtures get easily damaged due high frequency of usage. For example, to test the mother board, the fixture must be soldered to the mother board, and the completion of the testing, the solder has to be removed. Furthermore, in a case when the fixture is shared by multiple engineers, the testing efficiency is significantly affected.

### SUMMARY OF THE INVENTION

Therefore, it is an object of the present invention to provide a method for detecting and transmitting the error messages using a software module instead of using the fixture, so as to reduce the testing time and cost.

According to an aspect of the present invention a controller inside the local module is adopted for performing an error test to obtain a test result. Next, the controller is adopted for transmitting the test result to an application software in the local module. Finally, the application software is adopted for transmitting the test result to the remote module via a transmission interface.

According to an embodiment of the present invention, an instruction is provided by the input device and the controller executes the instruction to obtain a corresponding result. Next, and the controller transmits the result to the application software. Finally, the application software transmits the result to the I/O (Input/Output) device of the local module or transmits the result to the remote module via the transmission interface.

According to an embodiment of the present invention, the remote module provides an instruction to the application software, and the application software transmits this instruction to a controller. Thereafter, the controller executes the instruction to obtain a corresponding result. Next, the controller transmits the result to the application software. Finally, the application software transmits the result to the I/O (Input/Output) device of the local module or transmits the result to the remote module via the transmission interface.

Thus, the present invention utilizes the software module to detect and transmit the error messages instead of fixture, and therefore the disadvantages due to the use of fixture can be effectively avoided. In addition, the exact location where the error occurs during the data transmission and its detail on the circuit board can be detected by the remote module or the I/O device.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a circuit diagram of a conventional circuit for detecting and transmitting the error messages.

FIG. 2 is a detail structure diagram according to a preferred embodiment of the present invention.

FIG. 3 is a block diagram of a system for detecting and transmitting the error messages according to a first embodiment of the present invention.

FIG. 4 is a flow chart illustrating a method for detecting and transmitting the error messages according to the first embodiment of the present invention.

FIG. 5 is a block diagram of a system for detecting and transmitting the error messages according to a second embodiment of the present invention.

FIG. 6 is a flow chart illustrating a method for detecting and transmitting the error messages according to the second embodiment of the present invention.

FIG. 7 is a block diagram of a system for detecting and transmitting the error messages according to the third and fourth embodiments of the present invention.

FIG. 8 is a flow chart illustrating a method for detecting and transmitting the error messages according to the third embodiment of the present invention.

FIG. 9 is a flow chart illustrating a method for detecting and transmitting the error messages according to the fourth embodiment of the present invention.

FIG. 10 is a block diagram of a system for detecting and transmitting the error messages according to the fifth and sixth embodiments of the present invention.

FIG. 11 is a flow chart illustrating a method for detecting and transmitting the error messages according to the fifth embodiment of the present invention.

FIG. 12 is a flow chart illustrating a method for detecting and transmitting the error messages according to the sixth embodiment of the present invention.

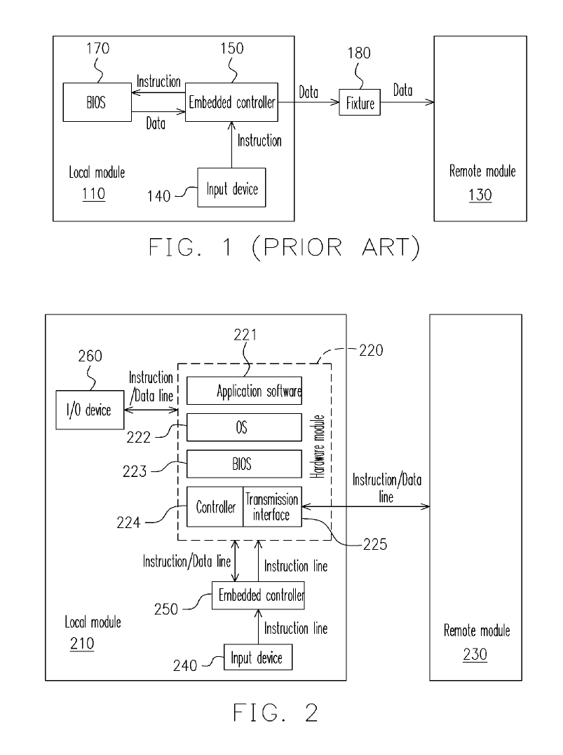

### DESCRIPTION PREFERRED EMBODIMENTS

FIG. 2 is a detail structure diagram according to a preferred embodiment of the present invention. The system of the present invention comprises a local module 210 and a remote module 230. The local module 210 comprises an input device 240, an embedded controller 250, a hardware module 220 and an I/O device 260. The hardware module 220 comprises a BIOS 223, a controller 224 and a transmission interface 225. In addition, an OS (Operating System) 222 and an application software 221 are stored in the hardware module 220.

The local module 210 may be comprised of a computer system and the input device 240 may be comprised of a keyboard or a mouse. The OS 222 may be DOS (Disk Operating System), Windows 2000/XP, or any other operating systems. The controller 224 may be a CPU (Central Processing Unit), a south bridge chip or a north bridge chip. The I/O device 260 may be a touch screen. The transmission interface 225 may be a USB (Universal Serial Bus), an IEEE 1394 or a network transmission interface. The transmission interface 225 is electrically connected to the remote module 230, wherein the remote module 230 may be an oscilloscope, a computer or a display device. The OS 222 and the application software 221 are stored in a memory device on the circuit board, and the OS 222 may provide the basic transmission control (e.g. controlling the transmission interface and the application software).

For the purpose of illustrating of the present invention, a computer with a pre-installed OS is exemplified hereinafter. It will be apparent to one of the ordinary skills in the art that the present invention can also be applied in other circuit boards, thus the present invention is not limited to such hardware combination.

When the user uses the input device 240 to input an instruction to the computer system (the local module 210), the instruction is sent to the embedded controller 250. Wherein, the instruction may be either an instruction of activating the embedded controller 250 to transmit the error message to the hardware module 220 or an instruction to the BIOS 223.

If the instruction input by the user is intended to activate the embedded controller 250 to transmit the error message, the embedded controller 250 performs an error test procedure and transmits the test result to the hardware module 220. Then, this data is sent to the controller 224 in the hardware module 220. Afterwards, with the help of the OS 222, the application software 221 integrates the error test data and outputs the result either to the remote module 230 or to the I/O device 260.

If the instruction input by the user is intended to provide an instruction to the BIOS 223, the instruction is provided to the embedded controller 250 and then transmitted to the BIOS 223. Then, the BIOS 223 executes the instruction and performs the error test, and the procedure and results of the error test are transmitted to the controller 224 in the hardware module 220 or output to the embedded controller 250. Afterwards, with the help of the OS 222, the application software 221 integrates the error test data and outputs the result to the remote module 230 or the I/O device 260.

The application software 221 outputs the error test data in two different ways. If the error test data is output to the remote module 230 via the transmission interface 225, e.g. output to the oscilloscope connected to the USB, the error test data is then displayed on the oscilloscope. Alternatively, if the error test data is output from the I/O device 260, the error test data is displayed on the touch screen. The manner of outputting the error test data is determined by the embedded controller 250, the application software 222, or the instruction input by the user. However, it will be apparent to one of the ordinary skills in the art that other options are also within the scope of the present invention.

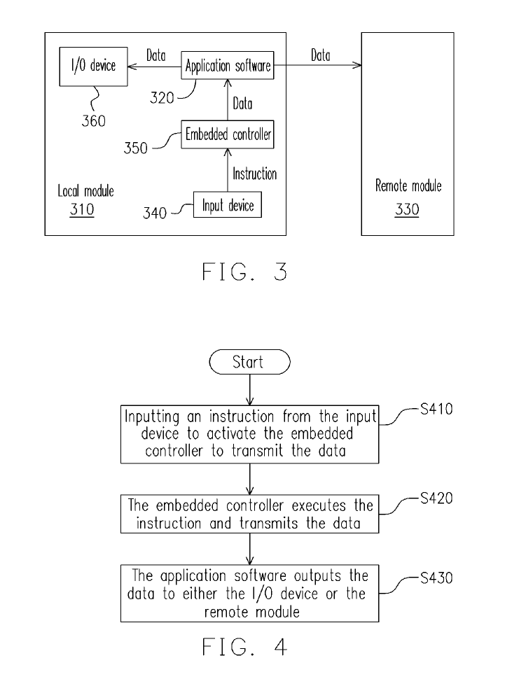

Hereinafter, a detail description of inputting the instruction from the input device in order to request the embedded controller to transmit the data is described in greater detail in the first embodiment of the present invention with reference to FIG. 3 and 4. FIG. 3 is a block diagram of a system for detecting and transmitting the error messages using the software module, and FIG. 4 is a flow chart illustrating a method for detecting and transmitting the error messages.

Referring to FIG. 3, the system comprises a local module 310 and a remote module 330. The local module 310 comprises an input device 340, an embedded controller 350, an application software 320 and an I/O device 360.

When the user inputs an instruction to the local module 310 via the input device 340, the instruction is sent to the embedded controller 350 to request the embedded controller 350 to transmit the data (step S410). After the embedded controller 350 receives the instruction, the embedded controller 350 performs the error test and outputs the error test procedure and its results (step S420). Then, the data output by the embedded controller 350 is processed by the application software 320.

Afterwards, with the help of the OS, the error test data is output to either the I/O device 360 or the remote module 330 (step S430). Wherein, the output path of the error test data is determined by the embedded controller 350, the application software 320, or the instruction input by the user. However, it will be apparent to one of the ordinary skills in the art that any other options may also be used to achieve the purpose of the present invention and are construed to be within the scope of the present invention.

If the error test data is sent to the I/O device 360 such as a computer system, the result is then displayed on the touch screen. Alternatively, if the predetermined data output terminal is the remote module 330, the error test data is displayed on the oscilloscope or another computer system via the USB.

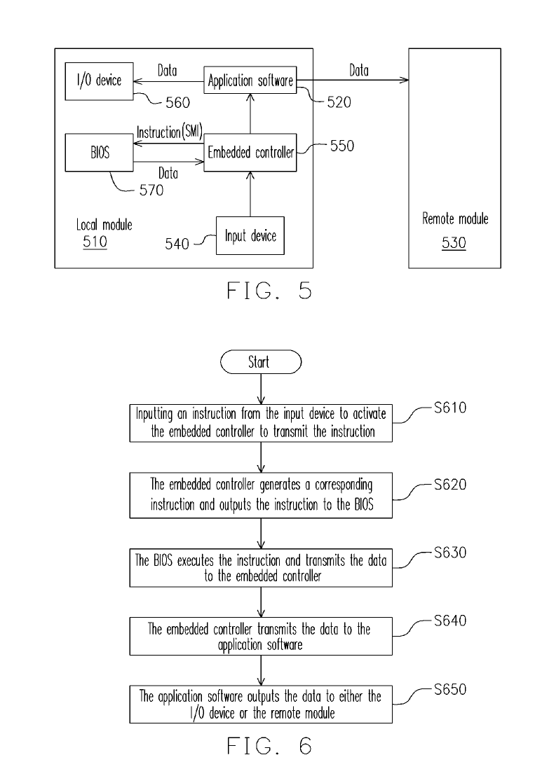

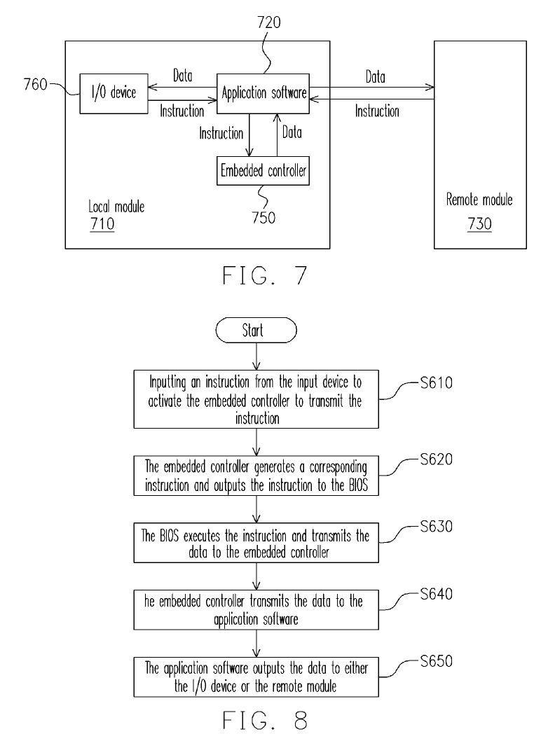

Hereinafter, a detail description of inputting the instruction from the input device in order to request the BIOS to transmit the data is described in greater detail according to the second embodiment of the present invention with referring to FIG. 5 and 6. FIG. 5 is a block diagram of a system for detecting and transmitting the error messages using the software module, and FIG. 6 is a flow chart illustrating a method for detecting and transmitting the error messages using the software module.

Referring to FIG. 5, the system comprises a local module 510 and a remote module 530. The local module 510 comprises an input device 540, an embedded controller 550, an application software 520, an I/O device 560 and a BIOS 570.

When the user inputs an instruction to the local module 510 via the input device 540, the instruction is sent to the embedded controller 550 to request the embedded controller 550 to transmit the data (step S610).

After the embedded controller 550 receives the instruction, a corresponding instruction is generated and then sent to the BIOS 570 (step S620). After the BIOS 570 receives the instruction, the BIOS 570 performs the error test and generates the error test procedure and its results, and sends the results back to the embedded controller 550 (step S630). If the instruction is a SMI (System Management Interrupt), the BIOS 570 is triggered to transmit the data to the embedded controller 550, wherein the data is the transmission procedure and test results of the BIOS 570.

After the error test data is received by the embedded controller 550, the data is then transmitted to the application software 520 (step S640). Then, the data output by the embedded controller 550 is processed by the application software 520, and with the help of the OS, the error test data is output to either the I/O device 560 or the remote module 530 (step S650). Wherein, the output path of the error test data is determined by the embedded controller 550, the application software 520, or the instruction input by the user. However, it will be apparent to one of the ordinary skills in the art that any other options may also be used to achieve the purpose of the present invention and are construed to be within the scope of the present invention.

If the error test data is sent to the I/O device 560 such as a computer system, the result is then displayed on the touch screen. Alternatively, if the predetermined data output terminal is the remote module 530, the error test data is then displayed on the oscilloscope or another computer system through the USB.

Hereinafter, a detail description of inputting the instruction from the I/O device in order to request the embedded controller to transmit the data is described in detail according to the third embodiment of the present invention with referring to FIG. 7 and 8. FIG. 7 is a block diagram of a system for detecting and transmitting the error messages using the software module, and FIG. 8 is a flow chart illustrating a method for detecting and transmitting the error messages using the software module.

Referring to FIG. 7, the system comprises a local module 710 and a remote module 730. The local module 710 comprises an embedded controller 750, an application software 720 and an I/O device 760.

When the user inputs an instruction to the local module 710 via the I/O device 760, the embedded controller 750 is activated to transmit the data, the instruction is then sent to the application software 720 (step S810). With the help of the OS, the instruction is then sent to the embedded controller 750 from the application software 720 (step S820).

After the embedded controller 750 receives the instruction, the embedded controller 750 performs the error test and outputs the error test procedure and its results (step S830). Then, the data output by the embedded controller 750 is processed by the application software 720, and with the help of the OS, the error test data is output to either the I/O device 760 or the remote module 730 (step S840). Wherein, the output path of the error test data is determined by the embedded controller 750, the application software 720, or the instruction input by the user. However, it will be apparent to one of the ordinary skills in the art that any other options may be also be used to achieve the purpose of the present invention and are construed to be within the scope of the present invention.

If the error test data is sent to the I/O device 760 such as a computer system, the result is then displayed on the touch screen. Alternatively, if the predetermined data output terminal is the remote module 730, the error test data is then displayed on the oscilloscope or another computer system via the USB.

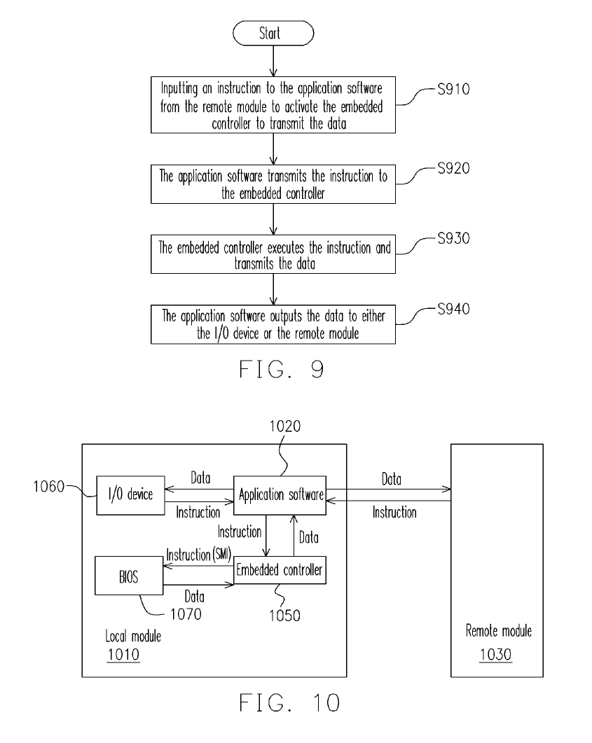

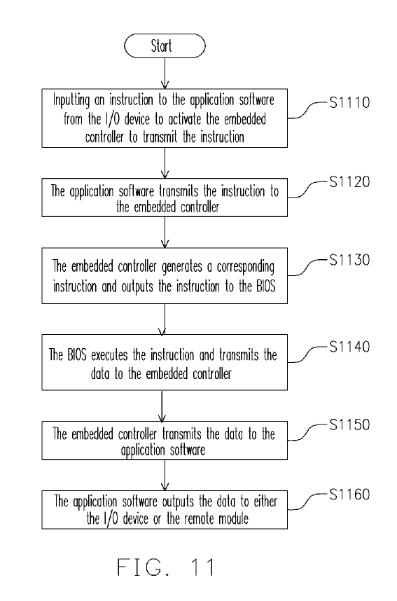

Hereinafter a detail description of inputting the instruction from the remote module in order to request the embedded controller to transmit the data is described in detail in the fourth embodiment of the present invention with referring to FIG. 7 and 9. FIG. 9 is a flow chart illustrating a method for detecting and transmitting the error messages.

This embodiment of the present embodiment is similar to the third embodiment except for a remote module 730 is used for inputting the instruction to the application software 720 in order to activate the embedded controller 750 to transmit the data (step S910). With the help of the OS, the instruction is sent to the embedded controller 750 from the application software 720 (step S920). After the embedded controller 750 receives the instruction, the embedded controller 750 performs the error test and outputs the error test procedure and its results (step S930).

Then, the data output by the embedded controller 750 is processed by the application software 720, and with the help of the OS, the error test data is output to either the I/O device 760 or the remote module 730 (step S940). Wherein, the output path of the error test data is determined by the embedded controller 750, the application software 720, or the instruction input by the user. However, it will be apparent to one of the ordinary skills in the art that any other options may also be used to achieve the purpose of the present invention and are construed to be within the scope of the present invention.

If the error test data is sent to the I/O device 760 such as a computer system, the result is then displayed on the touch screen. Alternatively, if the predetermined data output terminal is the remote module 730, the error test data is then displayed on the oscilloscope or another computer system through the USB.

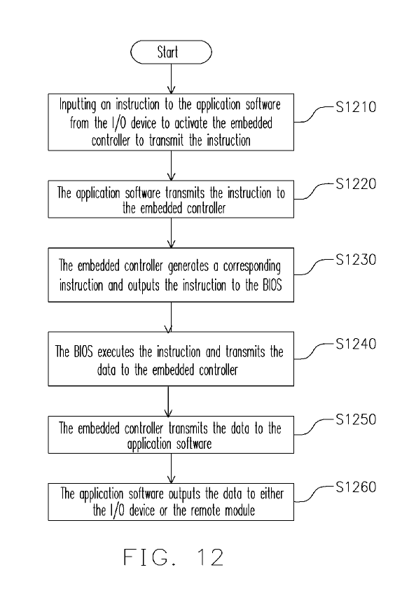

Hereinafter, a detail description of inputting the instruction from the I/O device in order to request the BIOS to transmit the data is described in detail according to the fifth embodiment of the present invention with reference to FIG. 10 and 11. FIG. 10 is a block diagram of a system for detecting and transmitting the error messages using the software module, and FIG. 11 is a flow chart illustrating a method for detecting and transmitting the error messages using the software module.

Referring to FIG. 10, the system comprises a local module 1010 and a remote module 1030. The local module 1010 comprises an embedded controller 1050, an application software 1020, an I/O device 1060 and a BIOS 1070.

When the user inputs an instruction to the local module 1010 via the I/O device 1060, the instruction is then sent to the application software 1020 (step S1110). With the help of the OS, the instruction is then sent to the embedded controller 1050 from the application software 1020 in order to activate the embedded controller 750 to transmit the instruction (step S1120). After the embedded controller 1050 receives the instruction, a corresponding instruction is generated and then sent to the BIOS 1070 (step S1130). After the BIOS 1070 receives the instruction, the BIOS 1070 performs the error test and generates the error test procedure and its results, and sends the results back to the embedded controller 1050 (step S1140). If the instruction is a SMI (System Management Interrupt), the BIOS 1070 is triggered to transmit the data to the embedded controller 1050, wherein the data comprises a transmission procedure and test results of the BIOS 1070.

After the error test data is received by the embedded controller 1050, the data is then transmitted to the application software 1020 (step S1150). Next, the data output by the embedded controller 1050 is processed by the application software 1020, and with the help of the OS, the error test data is output to either the I/O device 1060 or the remote module 1030 (step S1160). Wherein, the output path of the error test data is determined by the embedded controller 1050, the application software 1020, or the instruction input by the user. However, it will be apparent to one of the ordinary skills in the art that any other options may also be used to achieve the purpose of the present invention and are construed to be within the scope of the present invention.

If the error test data is sent to the I/O device 1060 such as a computer system, the result is then displayed on the touch screen. Alternatively, if the predetermined data output terminal is the remote module 1030, the error test data is then displayed on the oscilloscope or another computer system through the USB.

Hereinafter a detail description of inputting the instruction from the remote module in order to request the BIOS to transmit the data is described in detail according to the sixth embodiment of the present invention with referring to FIG. 10 and 12. FIG. 12 is a flow chart illustrating a method for detecting and transmitting the error messages using the software module.

This embodiment is similar to the fifth embodiment except for a remote module 1030 is used for inputting the instruction to the application software 1020 in order to activate the embedded controller 1050 to transmit the data (step S1210). With the help of the OS, the instruction is sent to the embedded controller 1050 from the application software 1020 to activate the embedded controller 750 to transmit the instruction (step S1220). After the embedded controller 1050 receives the instruction, a corresponding instruction is generated and then sent to the BIOS 1070 (step S1230). After the BIOS 1070 receives the instruction, the BIOS 1070 performs the error test and generates the error test procedure and its results, and sends the results back to the embedded controller 1050 (step S1240). If the instruction comprises a SMI (System Management Interrupt), the BIOS 1070 is triggered to transmit the data to the embedded controller 1050, wherein the data comprises a transmission procedure and test results of the BIOS 1070.

After the error test data is received by the embedded controller 1050, the data is then transmitted to the application software 1020 (step S1250). Next, the data output by the embedded controller 1050 is processed by the application software 1020, and with the help of the OS, the error test data is output to either the I/O device 1060 or the remote module 1030 (step S1260).

Wherein, the output path of the error test data is determined by the embedded controller 1050, the application software 1020, or the instruction input by the user. However, it will be apparent to one of the ordinary skills in the art that any other options may also be used to achieve the purpose of the present invention and are construed to be within the scope of the present invention.

If the error test data is sent to the I/O device 1060 such as a computer system, the result is then displayed on the touch screen. Alternatively, if the predetermined data output terminal is the remote module 1030, the error test data is then displayed on the oscilloscope or another computer system through the USB.

In summary, the present invention provides a method for detecting and transmitting the error messages where welding the fixture to the hardware during the data transmission test is not required. Accordingly, the test procedure and results are obtained via the remote module or the I/O device, and the time and cost are both reduced.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A method for detecting and transmitting an error message suitable for transmitting the error message from a local module to a remote module, comprising:
(a) performing an error test procedure and obtaining a corresponding error test result using a controller of the local module;
(b) transmitting the error test result to an application software in the local module using the controller; and
(c) transmitting the error test result to the remote module via a transmission interface using the application software.

2. The method for detecting and transmitting the error message of claim 1, further comprising:
(d) using an input device to input an instruction;
(e) using the controller to execute the instruction and obtain a corresponding instruction execution result;
(f) using the controller to transmit the instruction execution result to the application software; and
(g) using the application software to transmit the instruction execution result to an I/O device in the local module or to the remote module via the transmission interface.

3. The method for detecting and transmitting the error message of claim 2, wherein the step (e) further comprises:
(e1) using the controller to transmit the instruction to a BIOS in the local module;
(e2) using the BIOS to execute the instruction and obtain the instruction execution result; and
(e3) using the BIOS to transmit the instruction execution result to the controller.

4. The method for detecting and transmitting the error message of claim 2, further comprising a step of using the controller to select one of the I/O device and the remote module for transmitting the instruction execution result before the step (f).

5. The method for detecting and transmitting the error message of claim 1, further comprising:
(h) using the application software to transmit the error test result to an I/O device in the local module; and
(i) using the I/O device to display the error test result.

6. The method for detecting and transmitting the error message of claim 1, further comprising:
(j) using an I/O device in the local module to input an instruction to the application software;
(k) using the application software to transmit the instruction to the controller;
(l) using the controller to execute the instruction and obtain a corresponding instruction execution result;
(m) using the controller to transmit the instruction execution result to the application software; and
(n) using the application software to transmit the instruction execution result to the I/O device in the local module or the remote module via the transmission interface.

7. The method for detecting and transmitting the error message of claim 6, wherein the step l further comprises:
(l1) using the controller to transmit the instruction to a BIOS in the local module;
(l2) using the BIOS to execute the instruction and obtain the instruction execution result; and
(l3) using the BIOS to transmit the instruction execution result to the controller.

8. The method for detecting and transmitting the error message of claim 6, further comprising a step of using the controller to select one of the I/O device and the remote module for transmitting the instruction execution result before the step (m).

9. The method for detecting and transmitting the error message of claim 1, further comprising:
(o) using the remote module to input an instruction to the application software;
(p) using the application software to transmit the instruction to the controller;
(q) using the controller to execute the instruction and obtain a corresponding instruction execution result;
(r) using the controller to transmit the instruction execution result to the application software; and
(s) using the application software to transmit the instruction execution result to an I/O device in the local module or the remote module via the transmission interface.

10. The method for detecting and transmitting the error message of claim 9, wherein the step q further comprises:
(q1) using the controller to transmit the instruction to a BIOS in the local module;
(q2) using the BIOS to execute the instruction and obtain the instruction execution result; and
(q3) using the BIOS to transmit the instruction execution result to the controller.

11. The method for detecting and transmitting the error message of claim 9, further comprising a step of using the controller to select one of the I/O device and the remote module for transmitting the instruction execution result before the step (r).

12. The method for detecting and transmitting the error message of claim 1, wherein the transmission interface comprises a USB (Universal Serial Bus) interface.

13. The method for detecting and transmitting the error message of claim 1, wherein the transmission interface comprises an IEEE 1394 interface.

14. The method for detecting and transmitting the error message of claim 1, wherein the transmission interface comprises a network transmission interface.
